(19) United States
(12) Patent Application Publication
(10) Pub. No.: US 2016/0203130 A1
(43) Pub. Date: Jul. 14, 2016

(54) METHOD AND SYSTEM FOR IDENTIFYING AND EVALUATING SEMANTIC PATTERNS IN WRITTEN LANGUAGE

(71) Applicant: UNSILO A/S, Aarhus C (DK)

(72) Inventors: Francisco Roque, Bergen (NO); Mads Rydahl, Risskov (DK)

(21) Appl. No.: 14/915,625

(22) PCT Filed: Aug. 29, 2014
(86) PCT No.: PCT/EP2014/068396

§ 371 Date: Feb. 29, 2016

(30) Foreign Application Priority Data
Aug. 30, 2013 (EP) 13182452.6

(51) Int. Cl. G06F 17/30; G06F 17/27

(52) U.S. Cl. CPC G06F 17/30011; G06F 17/2705; G06F 17/30958

(57) ABSTRACT

The invention relates to a method and a computer program, as well as digital storage holding such, for identifying similar relationship patterns, concepts, or systemic units, described using any of a multitude of terminologies and vocabularies, across different knowledge domains in order to perform information searching. Using a simple web based interface and a language they understand, researchers can explore unfamiliar scientific domains to identify patterns and conceptual analogies that inspire radical breakthroughs.

### CROSS-REFERENCE TO RELATED APPLICATIONS

This application is a US national phase of International Patent Application No. PCT/EP2014/068396, filed on Aug. 29, 2014, which claims the benefit of European Patent Application No. EP 13182452.6, filed on 30 Aug. 2013, which are hereby incorporated by reference in their entirety.

### TECHNICAL FIELD

This invention relates to digital search technology, discovery and dissemination of knowledge, intellectual property, and product innovation.

### BACKGROUND

In recent years, Google has changed the way we solve problems. From the first-year design student to the experienced mechanical engineer, we all rely on Google Search as our point of entry.

But while Google excels in finding the most exact string matches and the most popular answers, it struggles in problem solving. Problem solvers do not seek exact answers, they want to explore and discover new knowledge, broaden their horizon, and understand both the subtleties and the complexities of a problem.

In academia, knowledge is documented and exchanged among peers using language and taxonomies designed to support further research within the same domain, not cross-domain exploration or serendipitous discovery. As a consequence, valuable scientific discoveries remain largely inaccessible to most of humanity, concealed by abstruse language in specialist journals.

Diving into unfamiliar, specialized scientific journals may be an appealing proposition to many researchers and innovators, but the accelerating pace of industry R&D has left little time for such extravagance. Today, information workers and R&D professionals already spend an average of 6-10 hours a week searching for the information they think they need. And our steadily growing mountains of information increase the demand for timely and relevant knowledge. R&D professionals want answers rather than links, and tools instead of content. They desire intelligent software that can help them explore and stay on top of an ever-growing corpus of scientific research.

In the domain of intellectual property, these challenges are even more apparent; patents are often written before terminology has been agreed upon, and the language used may even be intentionally crafted to capture the essence of what the inventor wishes to protect, while revealing as little as possible about the context. This may be to prevent unintended limitations on the claim scope, but might also be a deliberate strategy to prevent competitors from deducing business strategy from IP filings.

Keyword based search engines allow vast amounts of text to be indexed and searched really fast. The most popular search engine in history, Google, can find occurrences of a given text string in millions of documents within a few milliseconds. Unfortunately however, several systemic limitations prevent other relevant sources of knowledge and observed phenomena from being discovered using such traditional search technology:
Terminology: Academic literature, civilization's greatest repository of knowledge, often makes use of terminologies unknown to people unskilled in a specific academic discipline. This makes it hard for engineers and product designers to find and use relevant academic knowledge in remote technical areas, and hinders innovation.
Context-specificity: Furthermore, highly specialized language may imbue otherwise common words with alternate meanings, specific to a given context.

Consequently, when using traditional search tools, users may introduce unintended constraints on a solution space (e.g. by not using the exact same terms as an academic researcher would, or by using terms that have an alternate interpretation in the target context).
Shallow language understanding: Furthermore, while traditional search tools may take advantage of some contextual parameters, such as word order or word distance, as a signal of relationships between words (in the target corpus or in the query string), only a proper grammatical analysis can reveal the relationships between elements in a text, only a proper disambiguation can determine if the word “bank” refers to a geographic feature or a financial institution, and everything marginally relevant gets drowned in popular webpages. Just try to search for “a blue rabbit in a white ocean” on Google.
No knowledge of context boundaries: Traditional search tools cannot identify either “false positives” that contain words from the query string in unrelated contexts, or “false negatives” which have matched words spread across several locations in the text, or use terms or phrasing different from the query.

Even search engines that perform so-called “query expansion”, using synonym dictionaries, thesauri, patterns derived from past user queries, word sense disambiguation (WSD), and elaborate context specific rule-sets, often fail to locate relevant sources of information due to the abstract and conceptually convoluted nature of the phenomena and insights described in documents such as academic literature and patents.

It could be argued that this is because a conceptually unique insight may be encoded in words so common and plentiful as to make it disappear like a needle in a haystack.

Additionally, advanced systems that do employ advanced measures such as Natural Language Processing (NLP) and Word Sense Disambiguation (WSD) to construct a complex model of the meaning of written text, face the even harder problem of reasoning about it. An advanced reasoning engine may understand all the words used to describe a combustion engine, and even the causal relationships of the processes they support, but may still fail to deduce the purpose because that is too abstract or implied, and only hinted at in a technical description.

Once a described system or conceptualization reaches a certain complexity, a higher sense of purpose or utility, the timing or order of elements described, or even the simplest cause an effect relationships can be very hard to decode, and even harder to recognize as similar to something else, because the same system can be described with equal accuracy in an almost infinite number of ways.

Over the last 20 years, research on knowledge-based systems has gravitated towards tools like RDF and OWL to describe the objects, entities, properties, and relationships of a conceptualization in the form of an ontology, languages like SPARQL to retrieve and manipulate such ontologies, and reasoning systems like Fact++ or HermiT to use that knowledge, for instance to make recommendations to a user, or to guide the decisions of an autonomous agent.

In recent years, Natural Language Processing (NLP) techniques have matured to a point where NLP components are integral parts of many business-critical systems. It is now possible to extract complex relationship networks from plain English text using freely available tools. However, such implementations rely on hand-built rules and pre-existing domain-specific ontologies to achieve reasonable accuracy, and even high-performance reasoning systems degrade in performance when the knowledge base grows beyond a few million assertions.

In order to help a researcher find answers or useful inspiration from millions of documents, which each might contribute elements to a usable conceptualization, we would need to reason about millions of documents, each with thousands of assertions, for every single user query.

Given the present speed and accuracy of knowledge-based systems, the latency and cost of storage, the cost of computational resources, and the continued exponential growth in the amount of knowledge, a vision of open ended knowledge systems that provide access to and reasoning about all of human knowledge is taking shape, but with existing technology and approaches, this will remain both technically and financially unfeasible for the foreseeable future.

### SUMMARY

Accordingly, it is an object of the present invention to improve and simplify information searching, while at the same time increasing the relevance of text documents returned as result to a given search string, using novel indexing and retrieval strategies based on semantic understanding of text and concept relationships.

Accordingly, in a first aspect, the invention provides a method of indexing and searching text documents using abstracted semantic mappings and relationship patterns, comprising;
for each target document in the target corpus, the steps of:
   i. parsing the target document using natural language algorithms to produce an aggregated set of dependency graphs comprising terms and dependencies;
   ii. disambiguating at least one target term in the target document by assigning to the target term at least one semantic sense of the term;
   iii. identifying for at least one target term in the target document, a superset of senses with a semantic sense similar to at least one semantic sense assigned to said target term; and
   iv. constructing a semantic graph from the set of dependency graphs to represent at least two target terms in the target document and their relationship(s).
   v. optionally collapsing said semantic graph to link terms, phrases, and anaphors that reference the same semantic entities

In a preferred embodiment, the method may comprise retrieving or serving information based at least in part on one such semantic graph, comprising:
i. presenting a user interface that allow users to enter a query, and/or presenting an application programming interface (API) that allow a request to be submitted;
ii. processing a query and/or request to identify candidate query entities, including one or more of the following steps of
   1. parsing,
   2. disambiguating,
   3. identifying,
   4. constructing, and
   5. collapsing
iii. optionally constructing a semantic entity from said candidate query entities;
iv. optionally matching said semantic entity against at least one element from a semantic graph constructed from said target corpus;
v. compiling a response based at least in part on [at least] one such semantic graph; and
vi. returning said response to the user interface or API.

For each user query, the method preferably comprises identifying at least one matching target document which reference at least one said semantic entity also found in the given user query,

The method preferably further comprises, for at least one matching target document, determining if at least one attribute of the given user query which can be matched to a similar attribute of said target document, such attributes comprising
i. said semantic entities;
ii. links between said semantic entities;
iii. relationships between terms with the same identified superset of senses;
iv. attributes assigned during the disambiguation step, including
   1. semantic frames and frame relations; and
   2. semantic role labels and values;
v. attributes explicitly assigned by the user, including but not limited to
   1. bibliographic metadata; and
   2. author, institution, or assignee specific attributes, including but not limited to nationality, place of residence, past and present employers,

The method may further comprise identifying all matching target documents, iterating through all of them, and for each matching target document, calculating a score representing the amount of attributes from the given user query which can be matched to a similar attribute of said target document

Further, the method may comprise presenting matching target documents to the user, comprising one or more of:
i. presenting matching target documents as a list ordered by said calculated score;
ii. clustering the matching target documents by match context and presenting results as a list of the most prominent clusters; and
iii. providing interactive analytic tools quickly to filter target documents in a given cluster by metadata facets such as publication date, author, or affiliated institution.

In the same or another embodiment the method may further comprise the step of identifying, for a given target term, a superset of senses with a similar semantic sense comprising
identifying a taxonomy of related semantic senses that include the semantic sense determined for the given term, such as Princeton Wordnet (WordNet), the HGNC database (HUGO), or the Human Disease Ontology (HDO), including
   i. evaluating a list of candidate taxonomies, comprising for each candidate taxonomy
      1. calculating a measure of similarity between at least one sense from the candidate taxonomy and at least one sense assigned to the given term;
      2. determining a measure of topic matching between the candidate taxonomy and the target document by calculating at least one measure of similarity between at least one sense from the candidate taxonomy and at least one sense assigned to at least one term from the target document;
   ii. picking the best candidate taxonomy based at least in part on the topic matching or the measure of sense similarity;
identifying at least one semantic sense related to the semantic sense determined for the given term;
optionally identifying at least one superset of semantic senses related to the semantic sense determined for the given term;
optionally identifying a related superset of semantic senses comprising
   i. analysing the target corpus to determine the statistical weighting of at least one sense in the taxonomy;
   ii. analysing the taxonomy to determine a measure of similarity or distance between at least two of the senses in the taxonomy; and
   iii. clustering semantic senses in the taxonomy into supersets that contain similar senses.

In the same or another embodiment, the step of constructing a semantic graph may comprise, for each dependency graph
adding to the semantic graph a subgraph representative of the terms and dependencies in the dependency graph, wherein terms are mapped as nodes, and dependencies are represented as links or edges connecting the terms;
optionally applying a list of stop words to reduce graph complexity such that terms in the list of stop words are not mapped;
optionally ignoring specific dependency types to reduce graph complexity;
optionally representing certain dependencies as terms rather than edges, thereby reducing the number of ways a given statement can be mapped as a graph.

In the same or another embodiment the step of collapsing semantic graphs to link terms, phrases, and anaphors that reference the same semantic entities, may comprise identifying target terms or phrases in the target document that reference at least one said identified superset of senses like a semantic entity; and
optionally identifying target terms or phrases in the target document that reference known entities (including ideas, objects, persons, places, or phenomena) like a semantic entity;
optionally identifying target terms or phrases in the target document that are repeated multiple times like a semantic entity;
optionally identifying anaphors that reference instances of said semantic entities;
collapsing the semantic graph to a simpler structure by merging at least two nodes representing target terms or phrases or anaphors that reference the same semantic entity into a single collapsed node, comprising one or more of:
   i. aggregating node properties by conserving properties, such as links to neighbouring nodes, as an accumulated set of properties of said collapsed target node, when merging said source nodes in the semantic graph;
   ii. identifying similar neighbouring nodes in the accumulated set of neighbours of said collapsed target node;
   iii. merging said identified similar neighbouring nodes from the accumulated set of neighbours to further simplify the semantic graph;
   iv. aggregating node properties of said identified similar neighbouring nodes;
   v. deciding whether to merge nodes that reference the same semantic entity based on calculations performed on the available data e.g.
      1. the distance between the supersets of senses for each similar node, or
      2. the distance between the supersets of relationships that connect each similar node to said collapsed target node, or
      3. the aggregated evidence from the set of dependency graphs that reference any of the implicated target terms or phrases or anaphors;
   vi. continuing the process of merging and property aggregation until no nodes in the semantic graph have neighbours that qualify as similar according to any applicable rule.

In the same or another embodiment, the step of determining if at least one attribute of the given user query can be matched to a similar attribute of said target document, preferably further comprises
automatically relaxing the constraints imposed by the terms of the given user query to ensure that a minimum number of candidate target documents can be matched and optionally scored;
optionally determining which source terms of the given user query to relax or generalize based on statistical knowledge of the prevalence of specific terms, specific supersets of senses, and other attributes in the target document corpus;
optionally determining which alternate terms might replace the source term of the given user query to achieve the optimal relaxation, using contextual signals of source term importance, such as
   i. explicit user input (e.g. “don't relax this” or “this can be relaxed”); and
   ii. implicit user input or session context (e.g. the term “dolphin” has been a recurring term in recent queries so it must be important, or one of the terms may be an important vector in the cluster).

In the same or another embodiment, the optional step of identifying a related superset of semantic senses may further comprise pattern-based synonymy inference, comprising
for words in user queries (or target documents) that cannot be recognized or disambiguated;
calculating a probability-based disambiguation based on either
   i. co-occurrence of nearby semantic senses; or
   ii. co-occurrence of the previous N words;
   iii. co-occurrence of the next N words;
   iv. co-occurrence of the surrounding N words.

In the same or another embodiment, the method further comprises identifying at least one matching target document which reference at least one said semantic entity also found in the given user query further comprising unfolding all the documents graphs and storing them in a high performance key store such as levelDB, comprising
for each node in each target semantic graph,
   i. storing key entries representative of edges (connections between nodes) related to said node;
   ii. optionally using the identified superset of the target nodes as the key;
   iii. storing as the value for such entries, details that may be used for the evaluation and scoring of said edge against a user query;
   iv. optionally storing as the value, target term details from nodes related to the edge that may be used for the evaluation and scoring of said edge against the edges of a source user query;
   v. optionally also store longer paths (indirect connections) between nodes if the path has a lot of evidential support;
   vi. optionally use Dijkstra's algorithm to determine which connections to store;
at query time, for at least one edge in the given user query,
   i. retrieve matching edges from the keystore;
   ii. score target documents using at least in part details stored in the values of keys from said matched target document;
   iii. optionally score matched target documents using at least in part the target term details stored in the values of keys from said matched target document.

In the same or another embodiment, the step for each user query may further comprise presenting to a user, a User Interface (UI) that allow the execution of search queries against the indexed target corpus, the UI comprising
a search input affordance that allow users to input queries;
a results display component;
optionally, the results display component may support both a flat list of matched target documents and nested lists of matched target documents ordered in groups or clusters, where the matched target documents of each cluster share certain properties;
optionally providing user input assistance and query refinement suggestions using data aggregated during parsing of the target corpus;
optionally, as the user types a query, sending partial query graphs to the scoring service and retrieving lists of suggested senses, terms or term relationships that can be presented to the user as suggestions.

In a preferred embodiment, the user interface may feature a number of components, some of which may be used on their own, and others work in concert, comprising
a list of elements representative of result sets generated by the service or user activities, optionally including;
   i. results you have recently viewed;
   ii. actions by your clients or colleagues;
   iii. results that match a predefined set of rules, such as
      1. containing specific documents;
      2. containing specific products;
      3. containing specific inventors;
      4. containing specific companies;
      5. containing specific keywords;
      6. where matching may be fuzzy, such as to include similar documents, products, inventors, companies, or keywords.

In a preferred embodiment, the user interface may feature a number of components, some may be used on their own, and others work in concert, comprising a query input field featuring recommendations of additional query elements, constraints, or refinements and optionally one or more of the following:
i. presenting query elements as tokens or user affordances that produce suggestions to rephrase or replace the word with another term;
ii. featuring suggestions offered by the interface that include hypernyms or synonyms to terms in the user's query;
iii. offering other types of search input, such as direct graph manipulation, where queries are represented as graphs, and nodes can be added removed or edited using direct manipulation of the visual representation;
iv. allowing other input types than text, including URLs to text, pointers to local folders with text in the form of research documents, or URLs to web services that can provide information to be used as search input.

In the same or another embodiment, the UI comprises a results section, comprising
a list of results, wherein
   i. each result may reference a number of documents that share certain properties;
   ii. each result may represent a concept pattern, wherein a concept pattern is a variation from the query pattern common to several documents referenced in the result;
   iii. each results is representative of a cluster of matched documents grouped by a clustering algorithm that uses the structure of the semantic graph related to matched documents, the nodes within that graph matched to the given user query, or nodes connected to those matched nodes as input;
   iv. each result may represent a group of matched documents sharing specific contextual parameters, such as having particular neighbouring nodes or target concepts adjacent to the matched terms;
   v. each results may span multiple domains or document types, if clustered is done by similarity of the immediate match context, rather than the most prominent high level properties of the document.

In the same or another embodiment the method further comprises disclosing a Landing Page representative of a group of matched target documents, comprising graphs representative of the properties of the matched target documents, optionally including one or more of:
i. a list of matched target documents from said group of matched target documents;
ii. a list of authors from said group of matched target documents;
iii. a timeline or multidimensional plot where the entries are documents from said group of matched target documents and the times are publication dates;
iv. 3D visualizations.

The Landing page may optionally further comprise one or more of the following:
an implementation where said graphs are interactive and configurable to allow the filtering of said group of matched target documents;
user affordances to filter said group of matched target documents according to innate properties of the documents themselves or properties of how the documents relate to said group or to a given user query;
user affordances that allow the user to add or remove elements of the page and customize it to match the users workflow;
user affordances to add or view personal notes or public posts from other users of the service, allowing so users can paste links to related stories in the press, or suggest ideas for applications;
a simplified abstract that can be read by non-experts.

Also disclosed are the following method steps for comparing and calculating measures of similarity of knowledge patterns in the context of larger knowledge repositories. In relation to the present embodiment, this can be described using the concept of sets of nodes organized in graph structures.

In a preferred embodiment, the method further comprises comparing two subsets of nodes from a larger superset of nodes wherein each node represents a grammatical unit such as a noun phrase, and wherein each of the subsets represent an idea, an assertion, or a statement that comprises the nodes of the subset, and wherein each node has a link to at least one other node in the same subset, and wherein such link represents a property, relationship, or dependency (such as a grammatical predicate) of one of the nodes or between the linked nodes, comprising pairing the nodes so that at least one node from the first set is paired with at least one node from the second set, and calculating a measure of similarity between the two subsets based at least in part on a measure of distance in the superset between the nodes in each of the node pairs.

In a preferred embodiment, the method further comprises assessing the distance between two nodes in said superset according the comparisons of knowledge patterns, where the superset is organized at least in part using parent-child relationships, and where a parent node at least in part describes the child node, and where a child node at least in part share the characteristics of the parent node, and where the measure of distance between two nodes in the superset is smaller when said two nodes are parent-child and larger when said two nodes share a parent, and even larger if said two nodes are not related. The superset is preferably a dictionary of grammatical units such as noun phrases.

In these comparisons of knowledge patterns, the nodes in the superset may be noun phrases organized by a semantic relationship such as “is a member of” or “is a type of”. Also, the measure of similarity between said two subsets may be used at least in part to sort or filter a list of entities represented by such subsets. Further, each said subset may comprise at least one node, and where each said subset comprises at least one noun phrase. Also, each said subset may be used to describe an idea, an assertion, or a statement.

The invention can be implemented by means of hardware, software, firmware or any combination of these. Thus in a second aspect, the invention provides software or a computer program product for carrying out the method according to the first aspect. Further, in a third aspect, the invention provides a digital storage holding a computer program product or software configured to perform the method of the first aspect when executed by one or more digital processing units. The digital storage may be any one or more readable mediums capable of storing a digital code, such as discs, hard drives, RAM, ROM etc., the software can be on a single medium (e.g. on a single computer or server) or distributed on several media, e.g. on storage in different servers connected via a network, or others types of digital storage.

The gist of the present invention is to offer a simple search interface where users can type in a design problem or engineering challenge and get matching results from millions of patents and peer-reviewed articles. Results are presented as clusters of documents that describe similar phenomena, often from several different domains (e.g. biology, engineering, and chemistry). Using visualization widgets, users can customize the presentation of knowledge clusters to match their workflow and habits.

Since the principles of the invention apply equally well to finding similarities between any concept or systemic unit described using a variety of terminologies and vocabularies across multiple domains, the invention may find application in many areas of business and industry. Specifically, the invention can improve search breath and information retrieval efficiency in the intellectual property domain, but eventually our invention may add value to every aspect of product development as well as academic research.

In brief, the invention can be used to identify similar relationship patterns, concepts, or systemic units, described using any of a multitude of terminologies and vocabularies, across different knowledge domains by dynamically abstracting, generalizing, simplifying and de-localizing internal relationships and node types before comparing the systemic units. Using a simple web based interface and a language they understand, researchers can explore unfamiliar scientific domains to identify patterns and conceptual analogies that inspire radical breakthroughs.

In the past, an engineer trying to solve a problem relating to low operating temperatures might search Google for “anti-freeze” to find the top ranked documents containing that word. Expensive research discovery software might also find documents that contain “ethylene glycol” or “glycerol”.

In contrast to traditional keyword search, the invention provides the advantage of understanding complex queries, such as “fluids that prevent freezing”, and finding results that are not individual documents that happen to contain the words of the query, but concepts identified as Semantic Patterns across many scientific articles. For instance, the query from our engineer could be generalized to “matter that impedes hardening”, which would also match materials in other states such as gases, materials that do not prevent but perhaps only delay freezing, and materials that can prevent crystallization. For each matching concept, the invention would present a list of influential articles, the most prominent researchers and institutions working on this concept. The invention preferably also provides a set of visualization widgets designed to help users understand the concept, and quickly decide if it might be applicable to their challenge.

Consequently, this invention relates to finding ideas, concepts, and phenomena described in written language, using a variety of indexing and querying techniques to improve the matching of user queries to documents with a similar or related meaning.

### BRIEF DESCRIPTION OF THE FIGURES

FIGS. 1A and B depict exemplary dependency graphs, and FIG. 1C depicts the resulting semantic graph.

FIG. 2 illustrates the process of collapsing parsing a document to obtain a set of dependency graphs, forming a semantic graph, and forming a collapsed semantic graph.

FIG. 3 shows a computer system with a client computer and a server computer for running programs according to the invention.

FIG. 4 shows components on the server computer of FIG. 3.

### DETAILED DESCRIPTION OF THE INVENTION

In the following, number of concepts and terms are first defined and described in more detail in order to aid the interpretation of the language used herein. Further, a number of additional embodiment and examples of how to carry out specific elements of the invention are described.

In this present context, a document may be a text file containing written language, parsing may be done using natural language algorithms, such as the Stanford Probabilistic Parser, to construct a dependency tree of terms and dependencies. In said context, a semantic graph is to be understood as any spatial or virtual organisation of nodes that reference terms or semantic entities, optionally connected by links that reflect a connection or dependency between terms found in said document, in another representation of said document, or in any other parsed document. However, in some applications, a document may be a photo, a video file, or an audio file, and the parsing may be done using image recognition, computer vision, or signal processing software. In said other embodiment, a term may be a first object or first object class identified in a photo by said software, and a dependency may be a property of the observed first object, the identification of a particular second object in the same photo or document, or a property such as the location, orientation, direction, or speed of, or relative distance to, any object or term identified in said document.

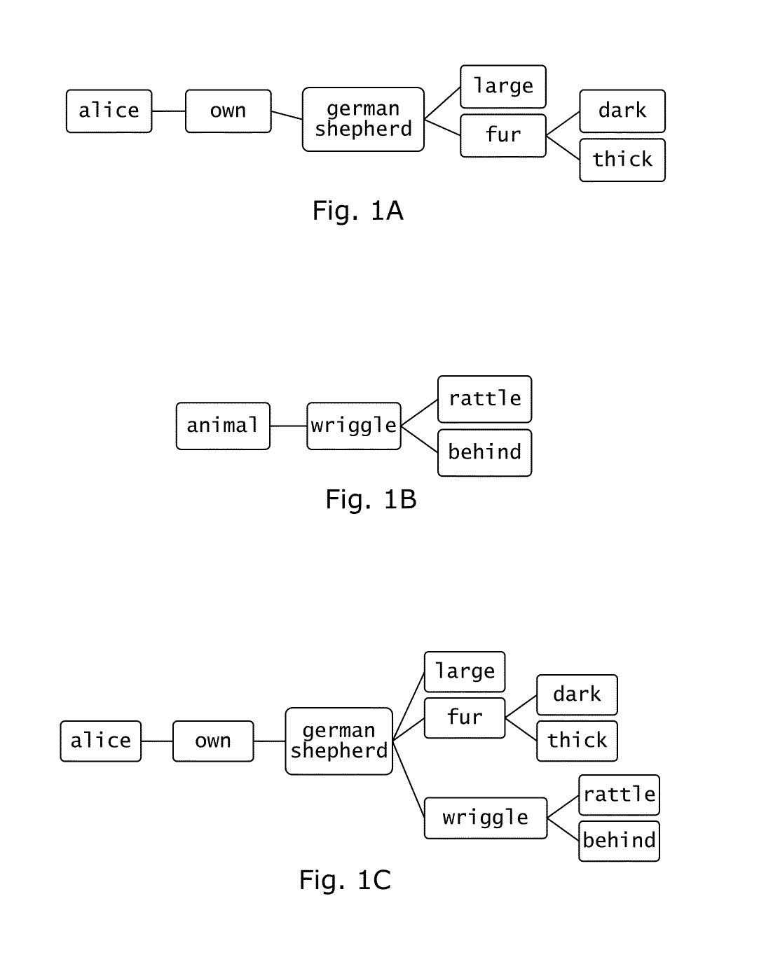

For example, a dependency graph reflecting the terms and dependencies in the sentence: “Alice owned a large German shepherd with thick, dark fur.” is depicted in FIG. 1A. Similarly, a dependency graph reflecting the terms and dependencies in the sentence: “The animal was wriggling its behind like a rattle.” is depicted in FIG. 1B.

A resulting semantic graph constructed from the two dependency graphs by merging nodes that reference similar semantic entities, in this example the nodes “german shepherd” and “animal”, would produce a semantic graph such as the graph depicted in FIG. 1C. Herein, some information, such as the ownership relationship derived from the verb “owned” or properties derived from adjectives such as “large”, may be represented as connected nodes, while others, such as comparisons (derived from the phrase “like a”) may be encoded as part of the edge.

In one implementation, sentences from a target document is parsed using the Stanford Probabilistic Parser, and The Stanford Parser Dependencies Representation output used to construct the edges and nodes of the semantic graph:

nsubj(owned-2, Alice-1)
root(ROOT-0, owned-2)
det(german-5, a-3)
amod(german-5, large-4)
dobj(owned-2, german-5)
vmod(german-5, shepherd-6)
amod(fur-11, thick-8)
amod(fur-11, dark-10)
prep_with(shepherd-6, fur-11)

Each dependency has a type attribute, and two dependent terms. In said implementation, both terms of said dependency are represented as nodes in the graph, connected by an edge with a type attribute that reflects the type and direction of said dependency. In said implementation, some dependency types, such as punctuation, may not be used to construct the semantic graph.

In the present context, disambiguating may refer to the identification of a semantic sense appropriate for the term. One measure of appropriateness may be the intent of the author of said document. Another measure of appropriateness may be statistical proof or aggregated evidence that a given sense is often intended or identified in a similar context, where such context may be defined as terms, objects, words or phrases identified in the same document. Disambiguation may use a reference corpus of text tagged by human editors with appropriate senses to identify a semantic sense. For example, in the sentence “Alice deposited money in the bank”, by comparing the set of terms in the sentence (including “money” and “deposit”) with sets of terms found in the same sentence as “bank” when used to identify a financial institution, we may pick an appropriate sense for the term “bank”. However, disambiguation may also refer to identifying the type, class or sub-class of an object or term identified in a photo, such as identifying the material used in a piece of clothing depicted in a photo, the skin colour of a person, or identifying whether a partially occluded object is a face or a pile of leaves.

In the present context, a superset of senses may refer to a collection of senses that are each other's synonyms, hyponyms, hypernyms, or meronyms, or that are used or appear in similar contexts, such as the terms “bank”, “reserve”, “treasury”, and “financial institution”. For a given term, said identified superset of senses may also be referred to as “the abstracted sense”. In some applications, a superset of senses may also refer to a plurality of senses that have something in common, or may serve a similar purpose or act in a similar role.

In one embodiment or implementation, the method according to the invention may comprise collapsing the semantic graph by merging or linking nodes that reference similar terms, phrases, anaphors, or semantic entities, and collapsing similar subgraphs into single strands that only diverge where the subgraphs diverge. In this context, collapsing refers to the steps of identifying merge candidate nodes, merging nodes that reference similar semantic entities, and marking nodes connected to a merged node as a merge candidate.

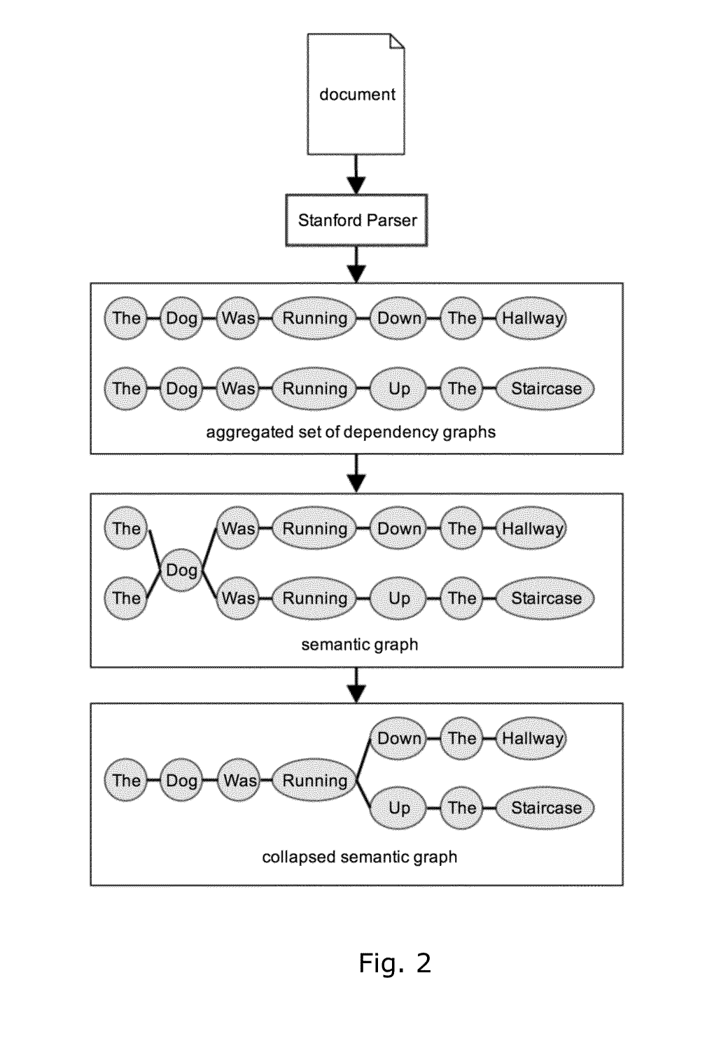

This step of identifying merge candidate nodes may comprise identifying every node that references a noun or a noun phrase in the target document, and the step of merging nodes that reference similar semantic entities may comprise analysing properties of the merge candidate nodes, and merging the merge candidate nodes that reference nouns or noun phrases with a similar semantic sense. In this embodiment, the collapsing of similar subgraphs is intended to mean that the subgraphs based on e.g. the two sentences “the dog was running down the hallway” and “the dog was running up the staircase” is collapsed into a single strand that diverge after the word ‘running’. This process is illustrated in FIG. 2.

This collapsing of similar subgraphs is preferably performed according to the steps of
given an open set of nodes,
find similar nodes in said set and merge them together.
for every set of similar nodes that are merged into a single node a new set should be created from the neighbours of the merged node
the new set should be added to the open set.

In this context, merging refers to combining the properties and links of a multitude of merge candidate nodes that reference similar semantic entities into one merged node with properties and links reflecting those of said multitude of merge candidate nodes. Said one merged node may either replace the multitude of merge candidate nodes in said semantic graph, or be added to the semantic graph as additional information. As described elsewhere in this description, said merging will allow said document to be matched to other queries than without the merging. Also, a semantic entity is an idea or concept referenced once or several times in said document using a term or set of terms, such as the concept of a “financial institution”, which may be referenced using terms such as “bank”, “treasury”, “investment firm” or “credit union”.

In another embodiment, however, a semantic entity may be any target idea, object or phenomenon, identified in the present document or another document, which can be referenced or described by a semantic graph, or by a semantic graph and a set of rules that describe the types and degrees of flexibility allowed for a candidate idea to be considered similar to the target idea. In the context of said second embodiment, computer vision software may identify a woman in a red dress with a flower in her hand as objects in a photo document. The sum of possible semantic entities identified in said photo document may comprise any combination or subset of the observed objects and their dependencies, or a combination of objects and dependencies observed in said photo document and objects and dependencies observed in another document. In the context of this embodiment, one possible semantic entity may include said woman, said red dress, and said flower, as well as properties and facts relating to the type of flower identified in said photo document identified in other photo documents, in other text documents, or retrieved from a knowledgebase, where such properties might include the species and classification order of plants that bear flowers similar to said flower, the reproductive morphology of said flower, or the animals it may have evolved in symbiosis with.

A further embodiment allows information based at least in part on a semantic graph or a plurality of semantic graphs may be stored in a searchable index, and involves retrieving information based at least in part on one such semantic graph, including constructing a semantic entity to search for, and searching said index to identify at least one matching element from one such semantic graph, compiling a response based at least in part on said semantic graph, and returning said response to a user interface or API.

In another embodiment of the invention, the process of storing information based at least in part on a semantic graph involves the steps of
selecting from said semantic graph, a set of nodes to be indexed;
for each node to be indexed,
   identifying a set of connected neighbour nodes; and
   storing information reflecting properties of each node to be indexed and the edges connecting said node to neighbour nodes.

In one embodiment, a subset of nodes to be indexed are selected, and for each index node, a set of connected neighbour nodes are selected based on the distance between said index node and nodes connected to said index node. Said distance may be calculated as the number of edges/links/hops between said nodes, and the distance may also be calculated using additional information about the nodes or edges connecting said nodes. For example, the edges of said semantic graph may include the amount or type of evidence in said document of dependencies or relations that support said edges as a weight parameter, and said distance may be calculated using a variation of a Dijkstra algorithm, where said distance is inversely correlated with the link weight or amount of evidence, such that connections between said nodes that are supported by a large amount of evidence have a lower calculated distance. In said embodiment, only information relating to connections between neighbours within a given maximum distance is stored.

In one example embodiment, a shortest path calculation is used to find which node pair combinations are going to be included in the index, using a Dijkstra algorithm to calculate node distances for the entire graph, and node pairs that have a distance lower than a given threshold are considered. The node pairs to be included in the index have to fulfil the following inequality:

$${D}_{P , Q} = {\sum }_{i = 1}^{{n}_{dijkstra}} \frac{1}{{f}_{{E}_{i}}} \leq 2$$

### Where:

D_{P,Q} is the lowest cost shortest path between nodes P and Q;
n_{dijkstra} is the number of edges between P and Q in the lowest cost path calculation;
f_{E} is the frequency of that given edge in the document.

For each node pair that passes the inequality above, we calculate an additional metric,

$${S}_{P , Q} = \{ \begin{matrix}min ( {S}_{pathL ( P , Q )} , {S}_{dijkstraL ( P , Q )} ) & if {S}_{pathL ( P , Q )} \leq 3 \\ {S}_{dijkstraL ( P , Q )} & if {S}_{path ( P , Q )} > 3\end{matrix} , {S}_{pathL ( P , Q )} = {\sum }_{i = 1}^{{n}_{edges}} i , {S}_{dijkstraL ( P , Q )} = {\sum }_{i = 1}^{{n}_{dijkstra}} i$$

the shortest path length between P and Q, defined as:

### Where:

S_{P,Q} is shortest path length between P and Q (number of edges);
n_{edges} is the number of edges between P and Q in the shortest path calculation

In this example embodiment, for each semantic graph, we may store a set of properties for each qualifying node pairs that pass said inequality, including but not limited to the abstracted sense for each node in said qualifying node pair, along with the D_{P,Q}, the S_{P,Q}, the actual path between the nodes of said qualifying node pair (as a list of node IDs) as calculated in D_{P,Q}, and the original terms references by each of the nodes of said qualifying node pair.

Also in this example embodiment, information pertaining to each said qualifying node pair is preferably stored as a key/value entry in an example high performance key store. The key is a string composed of two parts separated by a special character. The first part of the key identifies the two nodes of said qualifying node pair and comprise the abstracted sense identified for each of said nodes, sorted lexicographically and joined by an underscore character (‘_’). The second part of the key is the document identifier (DOI), and the two parts are joined by a dollar (‘$’) character. In said one example embodiment, the value of the entry contains properties of said node pair, and are encoded in a compact format to minimize the storage requirements of the index, as described by the example below. Since information is stored using the abstracted senses of the nodes, the same key may apply to several different qualifying node pairs in the semantic graph, and values from additional occurrences of qualifying node pairs with the same key are appended to the value using a pipe (‘|’) character as delimiter.

Further in this example embodiment, two example nodes may be found in an example semantic graph constructed from an example document with the DOI “10.116/j.mat.sci.10.12”, the Dijkstra weight of the lowest cost shortest path between said example nodes is calculated to be less than 2, and the abstracted senses identified for each of said example nodes are gas and motion. In said one example embodiment, we identify two occurrences of this key, one where the lowest cost path is 1.2, the shortest path is 3, the path traversed is [52, 31, 5, 43], and the original referenced terms are air and flow, and another where the lowest cost path score is 1.6, the shortest path length is 2, the traversed path is [3, 56, 89], and the original referenced terms are methane and circulation. In said one example embodiment, the resulting key/value entry would be:

| key | value |
|---|---|
| gas_motion$10.116/j.mat.sci. | “1.2;3;52,31,5,43;air;flow\|1.6;2;3,56,89, |
| 10.12 | methane,circulation” |

In one embodiment of the invention, the key/value pairs of such an index containing information constructed from many semantic graphs may be traversed systematically, and various properties of the key/value pairs aggregated and organized to produce e.g. a semantic frequency index with aggregated frequency counts for said abstracted sense pairs, or a frequency matrix that allow us to quickly access the most common neighbouring terms, senses, or abstract senses of a given term, sense, or abstract sense for a given part of the corpus, or globally for all of the indexed corpus. The contents of such a frequency matrix could be used to modify user queries, either to balance index performance by removing very common (high frequent) and therefore possibly not very descriptive edges, or attaching any high frequent nodes to neighbours in the query graph that are less frequent. Because the scoring algorithm has a given maximum distance that allows for matching patterns where terms in the document text are arranged in a different syntax, and semantic graphs where node order is swapped around a bit, especially when there is more than one or two pieces of evidence supporting a given phrase or term relationship, queries can be reformulated and edges shuffled around while still matching relevant documents that contain target terms in a approximately similar configuration to the same query.

Another aggregated output from such a systematic traversal of the index would be a graph-based semantic equivalent of the Google n-gram corpus, the contents of which might be used to provide input assistance, suggestions for additional terms, or suggestions for term replacements that might provide better, more, fewer, or more accurate, more personal, or more popular results. Instead of using a rigid n-grams for interactive query input auto-completion the invention could provide the building blocks around which to construct or complete semantically rich, fully formed syntactically correct query sentences using grammatical rulesets. This would allow the invention to help users use their own familiar terms to find documents and semantic entities that were never before described anywhere in the corpus or elsewhere using those terms. This is not accomplishable today using a naive brute force n-gram approach.

In another embodiment, information based at least in part on said semantic graph or a plurality of semantic graphs is stored in a database with a search interface that enable a method of retrieving information based at least in part on said semantic graph, where the method of retrieving optionally includes searching for specific attributes or properties of a semantic entity.

One implementation of the invention allows a user to submit a query using an input device such as a web browser displaying a user interface with a search form. For each such query, the invention comprises performing the optional steps of parsing, disambiguating, identifying, and constructing a query graph, and identifying matching target documents which reference at least one semantic entity similar to a semantic entity found in the user query using information based at least in part on semantic entities representative of said matching target documents.

The step of constructing a query graph may include the additional step of reformulating the query graph using a frequency matrix of terms or abstract senses to balance performance or provide better results.

For each matching target document, the method may comprise calculating a score that reflect how attributes from said user query match similar attributes of said target document, presenting information from matching target documents or reflecting aggregated properties of a set of matching target documents to the user, or presenting matching target documents as a list.

In another example embodiment, documents are scored based on which abstracted sense pairs are present in them and whether these compose a pattern that matches the query. In said one example embodiment, after a user inputs a query, the steps of parsing, disambiguating, identifying, and constructing a query graph are performed. From this query graph, the biggest connected component is extracted, and each edge and associated node pair becomes a query to said example high performance key store. For each edge in the connected component, we perform a range query to retrieve all the keys with said two abstracted senses (e.g. “gas_motion”). The resulting sets of keys are aggregated by document identifier (e.g. “10.116/j.mat.sci.10.12”), and for each document the score is calculated as:

$${Score}_{doi} = \{ \begin{matrix}max ( ∀ P , Q ∈ {hits}_{( doi , keyword )} \text{:} \frac{1}{max ( 1 , {D}_{P , Q} ) \times {S}_{P , Q}} \times \frac{1}{{max}_{keywords}} ) & if {n}_{keywords} = 1 \\ max ( {{\sum }_{i = 1}}^{{n}_{keywords ( CC )}} ∀ P , Q ∈ {hits}_{( CC , i )} \text{:} \frac{1}{max ( 1 + {D}_{P , Q} ) \times {S}_{P , Q}} \times \frac{{n}_{keywords}}{{max}_{keywords}} ) & if {n}_{keywords} > 1\end{matrix}$$

### Where:

n_{keywords} is the number of keyword pairs matched in the document
max_{keywords} is the number of keyword pairs in the query
CC is a connected component in the document graph matching the query

Matching target documents may also be arranged or classified into subsets, classes, or topics by a clustering algorithm such as K-means or a generative model such as LDA, by analysing the contents or semantic entities of each matching target document. The clusters or topics may be explored or subdivided further using interactive tools to filter documents by relevant metadata facets, such as publication date, author, and/or affiliated institution.

Searching using sub graph matching in a semantic graph, as described in the present invention also opens a number of novel clustering possibilities. First of all, the semantic graph introduces the concept of semantic distance as approximation of relevance. Accordingly, the relevance of a given document may depend partially on the semantic distance between matched query terms, matched semantic entities, matched connected components, and between other features of relevance identified in the document. For example, matching documents where all the matched semantic entities from a query appear close together in the semantic graph, are like to be more relevant than matching documents where the matched semantic entities are spread out across the graph. Furthermore, the more central placed and connected a semantic entity is in a semantic graph, the more likely it is that those entities are central to the topic of the article.

Furthermore, these observations and the notion of semantic proximity can be extended to enhance, qualify, filter or instrumentalize the otherwise static metadata of a document extracted at index time.

It may be preferred to provide a well qualified guess as to which entities and features identified in the document at index time, might be particularly relevant for the given query/document combination, and then use those most relevant entities to describe, categorize, or filter said document.

For example, if a user searches for “breast cancer”, the features in a matching document which are most relevant for the user are likely those directly or closely connected to the terms “breast cancer”, such as “tumor location”, “magnetic resonance imaging”, and “contrast agent”, not features mentioned “far away” in sections with no semantic links to any of the matched query terms, for example specific details regarding research funding.

In one embodiment, a novel exhaustive entity recognition algorithm is deployed, which identifies multiple potentially interesting semantic entities (PISE) in every sentence of a document, based on the part-of-speech classification provided by the NL parser, TFIDF analysis, Named Entity Recognition, Co-reference resolution or a combination of these approaches. During indexing, a multitude (maybe hundreds or thousands) of PISE from each document is saved in a datastore, and at query time, after identifying a set of matching documents (maybe hundreds or thousands), which all contain at least some of the semantic entities of the query, and conceivably describe somewhat similar phenomena, we retrieve the complete set of all PISE for every matched document, compare these sets to remove PISE that occur in just one or a couple of documents, as well as, at least in some cases, the very common PISE that occur in more than half of the matched document, and feed the remaining PISE to a topic model such as LDA.

In another embodiment, before feeding the PISE to the topic model, a measure of semantic proximity to the matched query nodes is applied to each of the PISE. This can be done by calculating a weight for each PISE base at least in part on the lowest cost shortest path between any node of the PISE and any matched query node, or more crudely, by using either a fixed cut-off that filters out PISE with a lowest cost shortest path greater than e.g. 2, or by sorting the PISE by lowest cost shortest path length, and selecting either a fixed number or a fixed percentage of the closest PISE.

Furthermore, the LDA probabilities of the PISE found in result sets may be aggregated, and a large co-occurrence matrix can be build, mapping semantic entities from user queries matched on target documents onto millions of PISE that have been observed to show a strong correlation with identified LDA topics in the result sets.

This co-occurrence matrix can be used to identify relevant historic user queries (by the current user or another user) topics, themes, and in particular, semantic entities relevant to the users current activities, or to a given document, simply be looking at the PISE from documents in the users current activity stream.

This combination of brute force entity extraction and asynchronous entity re-qualification and evaluation against a constant flow of result sets driven by human interest, is advantageous in that it could fuel discovery of underlying causalities and provide profound insights in well documented domains such as biomedicine.

Furthermore, such a PISE matrix built from a personal library, from viewed items in a users query history, or from their general activity stream, could be used to calculate very detailed user interest vectors to improve the accuracy of recommendation engines, in particular by massively improving overlap.

### Technical Implementation

The invention can be implemented by means of hardware, software, firmware or any combination of these. The invention or some of the features thereof can also be implemented as software running on one or more data processors and/or digital signal processors. FIG. 2 can also be seen as a schematic system-chart representing an outline of some of the operations of the computer program product according to an embodiment of the invention. The individual elements of hardware implementation of the invention may be physically, functionally and logically implemented in any suitable way such as in a single unit, in a plurality of units or as part of separate functional units. The invention may be implemented in a single unit, or be both physically and functionally distributed between different units and processors.

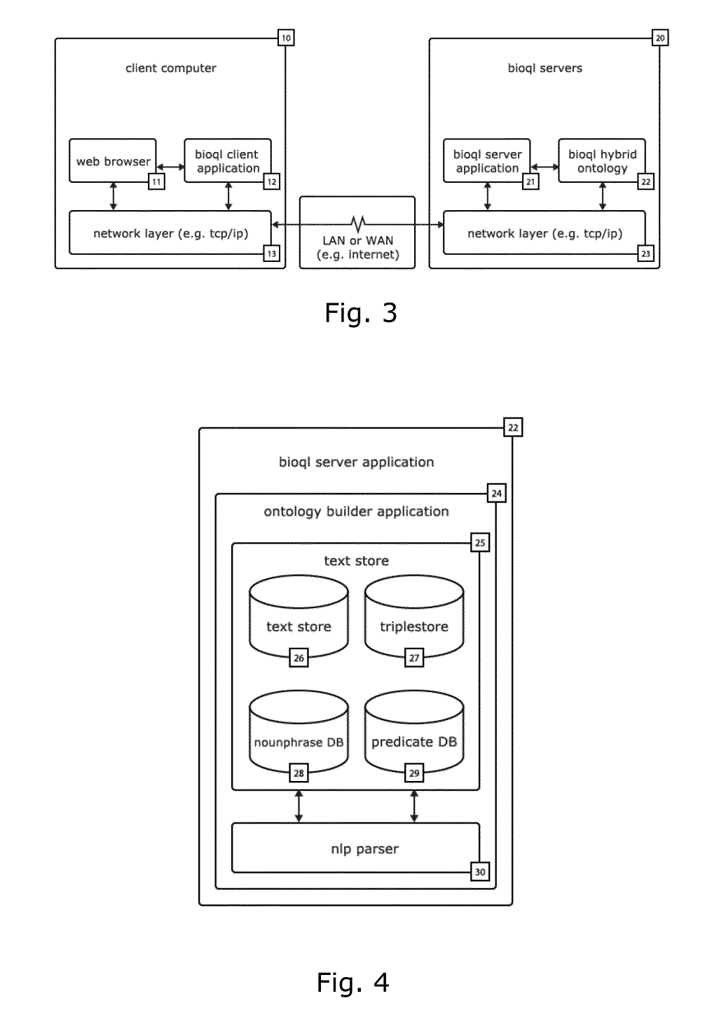

FIG. 3 illustrates a computer system with a client computer and a server computer for running programs according to the invention; and FIG. 4 illustrates components on the server computer; A client communicates with a server via LAN or WAN. The client consists of a browser (11) and a client (12). The client communicates via a network layer (13) with the server (20) via WAN or LAN. The server consists of a server application (21) and an ontology application (22) that communicates with the client protocol via a network layer (22).

The client application or web browser present the user interface of the application and submits information representative of user behaviour or client application state to the server application 21 via the network layer 13, either automatically or upon a user's command. The parameters can be e.g. a query string typed by the user, a user document or a data structure representative of the state and contents of a user document, the type and time of interaction with a client application, etc.

1. A method of indexing and searching text documents using abstracted semantic mappings and relationship patterns, for each target document in the target corpus, the method comprising:
parsing the target document using natural language algorithms to produce an aggregated set of dependency graphs comprising terms and dependencies;
disambiguating at least one target term in the target document by assigning to the target term at least one semantic sense of the target term;
identifying for the at least one target term in the target document, a superset of senses with a semantic sense similar to the at least one semantic sense assigned to the target term; and
constructing a semantic graph from the aggregated set of dependency graphs to represent at least two target terms in the target document and their relationship(s).

2. The method according to claim 1, further comprising serving information based at least in part on one such semantic graph, by:
presenting a user interface that allow a query to be submitted, and/or presenting an application programming interface (API) that allow a request to be submitted, either automatically or in response to user activities; and
processing a query and/or request to identify candidate query entities, including one or more of:
parsing,
disambiguating,
identifying,
constructing,
collapsing,
compiling a response based at least in part on one such semantic graph; or
returning the response to the user interface or API.

3. The method according claim 13, wherein collapsing the semantic graph comprises collapsing the sematic graph of the target document to link terms, phrases, and anaphors that reference the same semantic entities.

4. The method according claim 2, further comprising providing at least one query or request and disambiguating, identifying, and constructing the query to create a query graph.

5. The method according claim 2, further comprising, for at least one provided query or request, identifying at least one matching target document which reference at least one the semantic entity also found in the provided query or request.

6. The method according to claim 5, further comprising, for the at least one matching target document, determining if at least one attribute of the given query or request can be matched to a similar attribute of the target document, such attributes comprising one or more of:
the semantic entities;
links between the semantic entities;
relationships between terms with the same identified superset of senses;
attributes assigned during disambiguation; including:
semantic frames and frame relations and/or
semantic role labels and values; or
attributes explicitly assigned by the user, including:
bibliographic metadata; and/or
author, institution, or assignee specific attributes, including but not limited to nationality, place of residence, past and present employers.

7. The method according to claim 5, further comprising presenting matching the target documents to the user.

8. The method according claim 5, further comprising identifying, for a given target term, the superset of senses with a similar semantic sense comprising:
identifying a taxonomy of related semantic senses that include the semantic sense determined for the given term, including:
evaluating a list of candidate taxonomies; and
picking the best candidate taxonomy; and
identifying at least one semantic sense related to the semantic sense determined for the given term.

9. The method according to claim 5, further comprising:
constructing a semantic graph comprising, for each or a plurality of dependency graphs; and
adding to the semantic graph a subgraph representative of the terms and dependencies in the dependency graph, wherein terms are mapped as nodes; and dependencies are represented as links or edges connecting the terms.

10. The method according to claim 2, wherein the user interface features suggested query elements, constraints, or refinements, in the form of either text or URLs of text, pointers to local folders with text in the form of research documents, or URLs to web services that can provide information to be used as search input.

11. The method according to claim 2, wherein the user interface comprises elements representative of a plurality of matched target documents, graphs representative of the properties of the plurality of matched target documents, or user affordances to filter the plurality of matched target documents according to innate properties of the documents themselves or properties of how the documents relate to the plurality or to a given query or request.

12. A digital storage holding software configured to perform the method of claim 1 when executed by one or more digital processing units.

13. The method according to claim 1, further comprising collapsing the semantic graph to link terms, phrases, and anaphors that reference the same semantic entities.

14. The method according to claim 5, further comprising representing certain dependencies as terms rather than edges, thereby reducing the number of ways a given statement can be mapped as a graph.
